(19) United States
(12) Patent Application Publication
(10) Pub. No.: US 2004/0092242 A1
(43) Pub. Date: May 13, 2004

(54) Semiconductor integrated circuit including oscillator and semiconductor integrated circuit for communication

(76) Inventor: Takefumi Endo, Takasaki (JP)

Correspondence Address: Mattingly, Stanger & Malur, P.C., Suite 370, 1800 Diagonal Road, Alexandria, VA, 22314, US

(21) Appl. No.: 10/690,542

(22) Filed: Oct. 23, 2003

(30) Foreign Application Priority Data
Nov. 8, 2002 (JP) 2002-324814

(51) Int. Cl. H04B 1/06; H04B 7/00

(52) U.S. Cl. 455/264; 455/255; 455/258; 455/259; 455/260; 455/262

(57) ABSTRACT

There is provided a voltage controlled oscillation (VCO) circuit which can adjust the oscillation frequency without trimming and a semiconductor integrated circuit for communication comprising the same VCO circuit, wherein as the VCO circuit forming the PLL circuit, an LC resonance type oscillation circuit is used in which a plurality of capacitance elements are connected in parallel via a selection means such as a switch and the oscillation frequency is varied by changing the circuit constant (LC) depending on the selecting condition of the selecting means, moreover a comparing circuit for comparing the control voltage supplied to the VCO circuit from the loop filter of PLL circuit with the reference voltage and a frequency adjustment circuit for generating the signal to control the selecting means based on the comparison result of the comparing circuit are also provided to determine the signal to control the selecting means through the sequential comparison.

### BACKGROUND OF THE INVENTION

The present invention relates to the technology which can be effectively applied to a VCO (Voltage-Controlled Oscillation circuit) which can adjust an oscillation frequency and more particularly to the technology which can also be effectively applied to the VCO mounted to a semiconductor integrated circuit for communication for making communication, for example, with a semiconductor chip for an electronic tag having a radio communication function which is generally called a radio tag.

In a device for radio communication such as a semiconductor integrated circuit for high frequency used for modulation of transmitting signal and demodulation of receiving signal used for radio tag and mobile telephone, a PLL (Phase Locked Loop) circuit including a VCO to generate an oscillation signal of the predetermined frequency to be mixed with a receiving signal and a transmitting signal has been used.

The VCO used for such radio communication is always required to oscillate within the predetermined frequency but the oscillation frequency thereof is often deviated from the predetermined frequency range due to the manufacturing fluctuation. Therefore, the frequency of each VCO has been measured with the probe inspection and a capacitance value of the capacitance element forming the VCO has been adjusted with the trimming using a laser for the purpose of frequency matching. However, the adjustment method utilizing the trimming has a problem that the manufacturing cost rises.

On the other hand, as the PLL circuit which can automatically adjust the self-running frequency, there is proposed the invention (for example, see to the patent document 1) where a comparing circuit for comparing the control voltage supplied to the VCO from a loop filter with the reference voltage and a circuit for generating a trimming data based on the comparison result of such comparing circuit are provided.

[Patent document 1]

Japanese Published Unexamined Patent Application No. Hei 7(1995)-46123

### SUMMARY OF THE INVENTION

However, in the prior art invention, the oscillation frequency of VCO may be adjusted by varying a current flowing into the VCO depending on a trimming data. Therefore, in the system where the oscillation frequency of VCO is adjusted by varying a current like the prior art document, there is a problem that fluctuation of current consumption becomes too large.

It is therefore an object of the present invention to provide a voltage controlled oscillation circuit (VCO) which can adjust the oscillation frequency without trimming and a semiconductor integrated circuit for communication including the same VCO.

Another object of the present invention is to provide a voltage controlled oscillation circuit (VCO) which shows less variation of current accompanied with the adjustment of oscillation frequency and also provide a semiconductor integrated circuit for communication including the same VCO.

The aforementioned and the other objects and novel features of the present invention will become apparent from description of the present specification and the accompanying drawings.

The typical inventions disclosed in the present invention may be summarized as follows.

Namely, an LC resonance type oscillation circuit is used, in which, as the VCO (voltage Controlled Oscillation circuit) forming a PLL circuit, a plurality of capacitance elements are connected in parallel via a selecting means such as a switch, and an oscillation frequency is varied by changing the constant (LC) of the circuit depending on a selecting condition of the selecting means. Moreover, a comparing circuit for comparing a control voltage supplied to the VCO from a loop filter of the PLL circuit with the reference voltage, and a frequency adjusting circuit for generating a signal to control the selecting means based on the comparison result of the comparing circuit are provided. A signal for controlling the selecting means with the sequential comparison is determined.

In the LC resonance type oscillation circuit, the oscillation frequency sometimes fluctuates due to the manufacturing fluctuation of an inductor (L) and a capacitance forming the LC resonance circuit. However, according to the means described above, the frequency adjustment of VCO by the trimming using a probe is no longer required and thereby the manufacturing cost can be reduced. Moreover, since the oscillation frequency can be adjusted step by step by varying a capacitance value forming the LC resonance circuit, it is no longer required to vary the current for adjustment of oscillation frequency. Accordingly, an increase of the fluctuation of current consumption in the oscillation circuit is prevented.

### BRIEF DESCRIPTION OF THE DRAWINGS

FIG. 1 is a circuit diagram illustrating an embodiment of the practical circuit of a VCO (Voltage Controlled Oscillation circuit) to which the present invention is applied.

FIG. 2 is a circuit diagram illustrating an example of detail structure of a variable capacitance circuit forming the VCO of the embodiment.

FIG. 3 is a block diagram illustrating a practical example of a PLL circuit including the VCO for adjusting the oscillation frequency to which the present invention is applied.

FIG. 4 is a flowchart illustrating the flow of oscillation frequency adjusting procedure by the adjustment control circuit in the PLL circuit of the embodiment of FIG. 3.

FIG. 5 is a block diagram illustrating an example of structure of a semiconductor integrated circuit for communication including the PLL circuit of the embodiment.

### DETAILED DESCRIPTION OF THE PREFERRED EMBODIMENT

An embodiment of the present invention will be described with reference to the accompanying drawings.

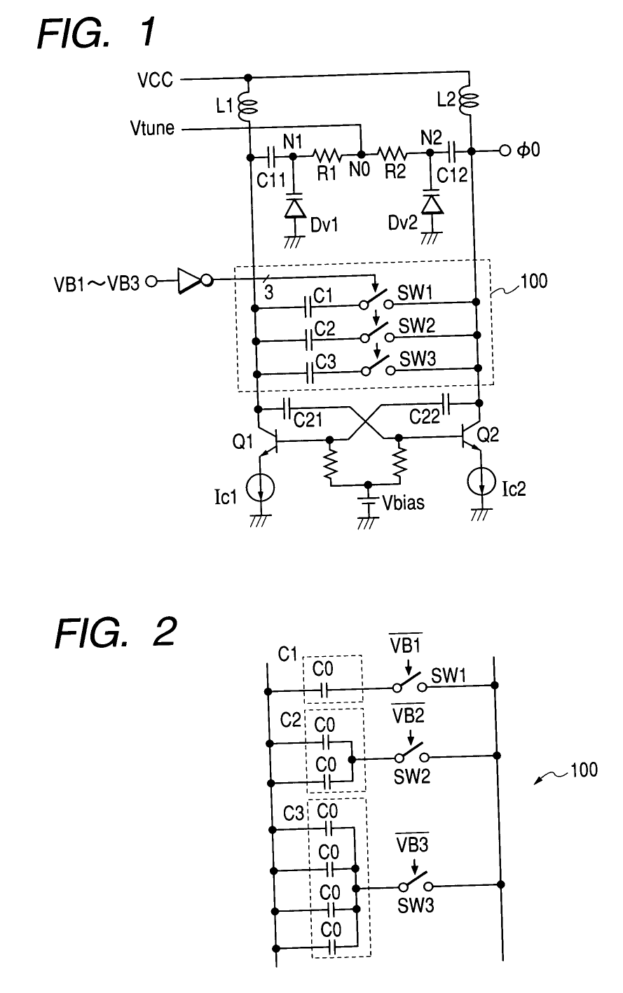

FIG. 1 illustrates an embodiment of the practical circuit of a VCO (Voltage Controlled Oscillation circuit) to which the present invention is applied.

An oscillation circuit of this embodiment is an LC resonance type oscillation circuit which includes inductance element (L) and capacitance element (C) to determine the frequency with LC value and this oscillation circuit comprises a pair of NPN bipolar transistors Q1, Q2 in which the bases and collectors are mutually cross-connected via the capacitances C21, C22, constant current sources Ic1, Ic2 connected between the emitters of the transistors Q1, Q2 and the grounding point GND, inductors (coils) L1, L2 respectively connected between the collectors of transistors Q1, Q2 and the power source voltage terminal Vcc, capacitance C11-resistance R1-R2-capacitance C12 connected in series between the collectors of the transistors Q1, Q2, a varactor diode Dv1 connected between the connection node N1 of the capacitance 11 and resistance R1 and the grounding point, a varactor diode Dv2 connected between the connecting node N2 of the resistance R2 and capacitance C12 and the grounding point, and a variable capacitance circuit 100 connected between the collector terminals of the transistors Q1, Q2. Moreover, a resistance and bias voltage Vbias are provided at the bases of the transistors Q1, Q2 to give a bias voltage.

The constant current sources Ic1, Ic2 have the identical current values, while inductors L1, L2, capacitances C11 and C12, C21 and C22, resistances R1 and R2, diodes Dv1 and Dv2 have identical values, respectively. The VCO of this embodiment is continuously varied in its oscillation frequency by varying the capacitance values of the varactor diodes Dv1 and Dv2 depending on the oscillation control voltage Vtune applied to the resistors R1, R2 and the connection node N0. The oscillation output φ0 may be extracted from any one of the connection nodes of the collectors of transistors Q1, Q2 and inductors L1, L2 and it is also possible to extract a differential output from both connection nodes.

The variable capacitance circuit 100 is configured by connecting in parallel three capacitances and three switches connected in series between the collectors of the transistors Q1, Q2 and switching the substantial capacitance value connected between the collectors of Q1, Q2 depending on the ON and OFF conditions of the switches SW1, SW2 and SW3. The capacitance values of capacitances C1, C2 and C3 are respectively set to have the weight of 2^{m} (m is a positive integer such as 0, 1, 2) and the frequency may be switched step by step by varying the capacitance value in the eight steps depending on the combination of the ON/OFF control signals VB1 to VB3 of the switches SW1 to SW3.

Although not particularly restricted, in the variable capacitance circuit 100, as illustrated in FIG. 2, one capacitance C0 (for example, 30 μF) is connected in series to the switch SW1, two capacitances C0 are connected in series to the switch SW2 and moreover four parallel capacitances C0 are connected in series to the switch SW3. With the structure described above, fluctuation among each capacitance may be lowered and a capacitance ratio can be set to a constant value even if capacitance were fluctuated.

Following table 1 illustrates the relationship between the ON/OFF conditions of the ON/OFF control signals VB1 to VB3 and switches SW1 to SW3 and the setting capacitance value of the variable capacitance circuit 100.

TABLE 1

| | | | | Connection | Total |
|---|---|---|---|---|---|
| VB1 to VB3 | SW1 | SW2 | SW3 | Capacitance | Capacitance |
| 111 | OFF | OFF | OFF | None | 0 |
| 110 | OFF | OFF | ON | C1 | C0 |
| 101 | OFF | ON | OFF | C2 | 2C0 |
| 100 | OFF | ON | ON | C1, C2 | 3C0 |
| 011 | ON | OFF | OFF | C3 | 4C0 |
| 010 | ON | OFF | ON | C1, C3 | 5C0 |
| 001 | ON | ON | OFF | C2, C3 | 6C0 |
| 000 | ON | ON | ON | C1, C2, C3 | 7C0 |

FIG. 3 illustrates a practical example of the PLL circuit including the VCO capable of adjusting the oscillation frequency to which the present invention is applied. In FIG. 3, a reference numeral 10 designates the VCO (Voltage Controlled Oscillation circuit) in the structure illustrated in FIG. 1. A reference numeral 20 designates a frequency comparing circuit for comparing the frequency of the frequency-divided signal divided for the oscillation signal φ0 of VCO 10 via a frequency dividing circuit 80 with that of the reference oscillation signal φref from the reference oscillation circuit such as a crystal-controlled oscillation circuit not illustrated and then outputting a voltage depending on the frequency difference. A reference numeral 30 designates a charge pump which operates depending on an output of the frequency comparing circuit 20. A reference numeral 40 designates a loop filter. A capacitance element of the loop filter 40 is charged up or discharged with the charge pump 30. Thereby, the oscillation control voltage Vtune of the VCO 10 is generated and is then supplied to the VCO. Accordingly, the VCO 10 is oscillated in the predetermined frequency through the PLL loop formed as described above.

In the above embodiment, a frequency-dividing circuit for dividing the oscillation signal φ0 of the VCO 10 is provided to feed back the signal obtained by dividing φ0 to the frequency comparing circuit 20. Thereby, it is no longer required to use the oscillation circuit of higher frequency to obtain the reference oscillation signal φref and the cost may be reduced by using a low price vibrator of lower frequency. However, it is also possible to feed back in direct the oscillation signal φ0 of the VCO 10 to the frequency comparing circuit 20.

The PLL circuit of this embodiment is provided, as illustrated in FIG. 3, with a voltage comparing circuit 50 for comparing the oscillation control voltage Vtune outputted from the loop filter 40 with the reference voltage Vref such as 1.3V, a frequency adjusting circuit 60 for outputting the control signals VB1 to VB3 of the capacitance switches SW1 to SW3 of the VCO 10 based on an output of the voltage comparing circuit 50, a switch SW0 for transferring an output of the voltage comparing circuit 50 to the frequency adjusting circuit 60 or cutting off this output, and an adjustment control circuit 70 for adjusting the oscillation frequency of the PLL loop by controlling operation of the switch SW0 and frequency adjusting circuit 60. Moreover, the frequency adjusting circuit 60 is also provided with a register REG for holding the setting condition of the VCO 10. The reference voltage Vref may be given, for example, from a constant voltage generating circuit such as the well-known band-gap circuit.

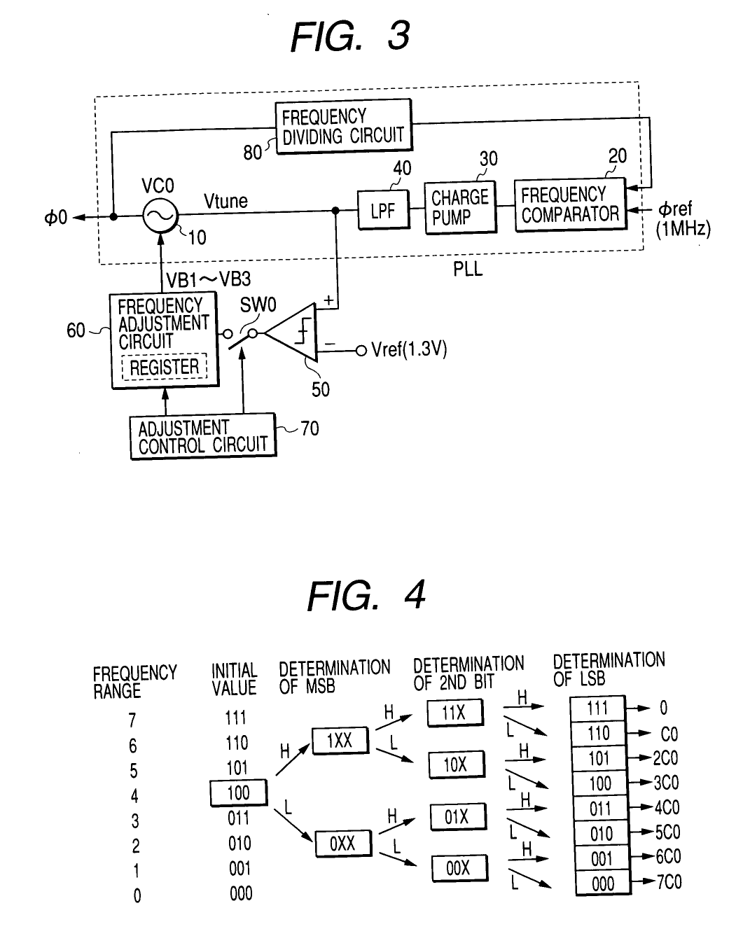

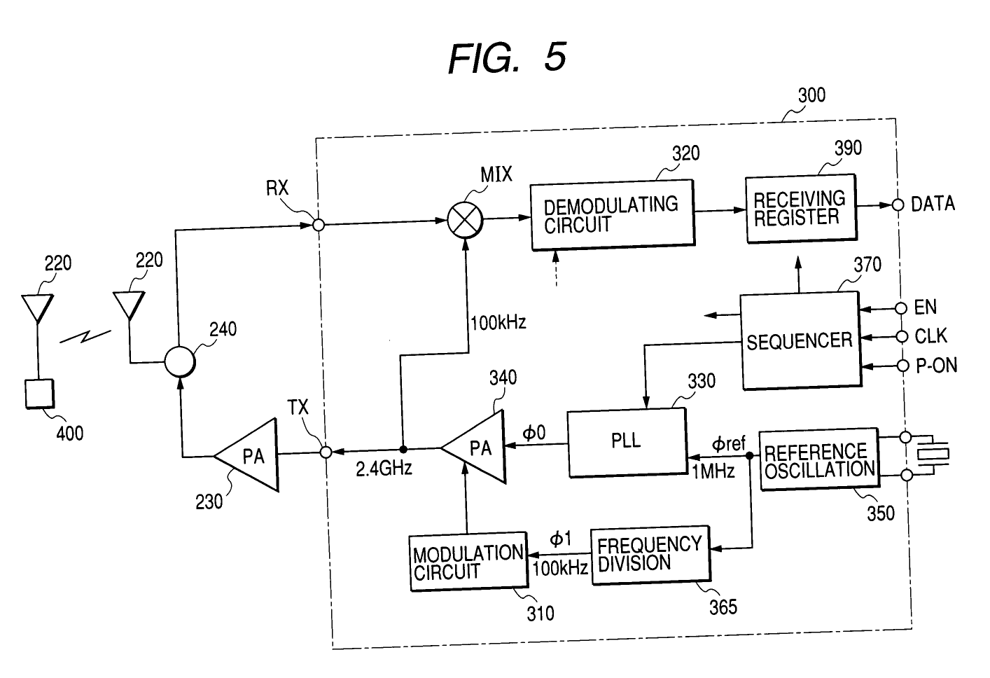

Next, the oscillation frequency adjusting procedure by the adjustment control circuit 70 will be described. FIG. 4 illustrates the flow of oscillation frequency adjusting procedure.

After the power source voltage is fed, automatic adjustment of oscillation frequency of the VCO is started in the predetermined timing. In this case, the PLL is set to the frequency of the design value with which the VCO 10 oscillates with the reference voltage Vref. Therefore the VCO starts the oscillation and the PLL enters the lock-up condition. The reference voltage Vref is equal to the design typical value of the VCO control voltage when the frequency range “100” is selected. In this case, the register REG is set to the intermediate value “100” of the frequency range of the PLL loop by the adjustment control circuit 70, the switches SW2 and SW3 in the VCO 10 are turned ON, and the oscillating operation is started under the condition that the capacitances C2 and C3 are connected. Subsequently, the frequency gradually rises. When the frequency divided from that of the oscillation signal φ0 of the VCO 10 is matched with the frequency of the reference oscillation signal φref, the PLL loop is stabilized.

The frequency adjustment circuit 70 turns ON the switch SW0 in the timing that the PLL loop is stabilized. Thereby, an output of the voltage comparing circuit 50 for comparing the control voltage Vtune supplied to the VCO 10 from the loop filter 40 with the reference voltage Vref is supplied to the frequency adjustment circuit 60 to detemine the most significant bit of the register REG depending on the voltage of the voltage comparing circuit 50. In more practical, since the oscillation frequency range of the VCO is lower than the design value when an output of the voltage comparing circuit 50 is in the high level, namely when the output voltage Vtune of the loop filter 40 is higher than the reference voltage Vref, the most significant bit is determined to “1” in order to adjust the oscillation frequency range up to the higher range. Moreover, when an output of the voltage comparing circuit 50 is in the low level, namely when the output voltage Vtune of the loop filter 40 is lower than the reference voltage Vref, the most significant bit is determined to “0” in order to adjust the oscillation frequency range up to the lower range.

Next, the adjustment control circuit 70 sets the second bit of the register REG within the frequency adjusting circuit 60 to “1” or “0” to switch the capacitance value of the variable capacitance circuit 100 within the VCO 10. Thereby, the frequency range of the VCO 10 varies depending on such capacitance value and the output voltage Vtune of the loop filter 40 changes. The frequency adjusting circuit 70 determines the second bit of the register REG from an output of the voltage comparing circuit 50 in the timing that the oscillation frequency is stabilized after the switching of frequency range. In more practical, when the output of the voltage comparing circuit 50 is in the high level, namely when the output voltage of the loop filter 40 is higher than the reference voltage Vref, the second bit is determined to “1”. Moreover, when the output of the voltage comparing circuit 50 is in the low level, namely when the output voltage Vtune of the loop filter 40 is lower than the reference voltage Vref, the second bit is determined to “0”.

Subsequently, the adjustment control circuit 70 sets the third bit of the register REG to “1” or “0” to switch the capacitance value of the variable capacitance value 100 in the VCO 10. After the frequency range of the VCO 10 changes depending on the capacitance value and the output voltage Vtune of the loop filter changes, the third bit (least significant bit) of the register REG is determined from the output of the voltage comparing circuit 50. According to this embodiment, as described above, the value to be set to the register REG can be determined with the comparing operation of the voltage comparing circuit 50 and the oscillation frequency range of the PLL circuit can be set, with this determination, to cover the desired frequency range.

In addition, when all bits of the register REG in the frequency adjustment circuit 60 are determined, the frequency adjustment circuit 70 turns OFF the switch SW0 to complete the frequency adjustment process by cutting off the output of the comparing circuit 50. As described above, variation of oscillation frequency due to the change of value of the register REG during the normal operation can be prevented by turning OFF the switch SW0. Moreover, the switch SW0 is not provided between the voltage comparing circuit 50 and the frequency adjustment circuit 60 but can be provided between the loop filter 40 and voltage comparing circuit 50. However, by providing the switch SW0 between the voltage comparing circuit 50 and the frequency adjustment circuit 60, the frequency changes due to change of the capacitance value of the loop filter 40 when the switch is turned ON and OFF is prevented.

Next, an example of the system where the PLL circuit of the embodiment described above is applied will be described below.

FIG. 5 is a block diagram illustrating an example of structure of the semiconductor integrated circuit for communication with a radio tag having the radio communication function and the radio communication system utilizing the same semiconductor integrated circuit.

In FIG. 5, 400 designates a semiconductor chip called a radio tag; 210, 220, antenna for transmission and reception of radio signal; 300, a semiconductor integrated circuit for communication with the radio tag via the antennas 210, 220; 230, a high frequency power amplifying circuit for amplifying the transmitting signal outputted from the semiconductor integrated circuit for communication 300 (hereinafter, referred to as a power amplifier); 240, a circulator for transmitting the transmitting signal to an antenna terminal 220 from the power amplifier 230 or transmitting the signal received by the antenna terminal 220 to a receiving input terminal RX.

A controller consisting of the semiconductor integrated circuit for communication 300, power amplifier 230 and a microprocessor, not illustrated, for controlling the semiconductor integrated circuit for communication 300 is formed as a module actually mounted on one printed circuit board. The power of transmitting signal outputted from the semiconductor integrated circuit for communication 300 is about 10 mW. Therefore, the power amplifier 230 may be eliminated for the system which can cover the communication range with such small power or for the chip which can receive a signal from the radio tag 400 as the communication partner having comparatively small output power.

The radio tag 400 comprises a power supply circuit which receives an AC signal outputted from the semiconductor integrated circuit for communication 300 with the antenna 210 and generates an internal DC power source by rectifying the AC signal with a diode bridge or the like, a receiving circuit for generating an operation clock signal by detecting the AM-modulated receiving signal, a built-in ROM storing the predetermined data such as ROM code, a transmitting circuit for transmitting the AM-modulated data read from the built-in ROM, and a logic circuit for executing the control to read the data from the built-in ROM depending on the request from the external side and also executing the predetermined arithmetic processes. The radio tag 400 is configured to be operated with the power in the voltage rectified with the power supply circuit to transmit the predetermined data using the carrier of the predetermined frequency. The antennas 210, 220 are respectively formed on the chip or printed circuit board through the wiring of the predetermined patterns.

The semiconductor integrated circuit 300 for communication is provided with a modulation circuit 310 and a demodulation circuit 320 to simultaneously realize transmission and reception. Although not particularly restricted, the AM modulation (amplitude modulation) system is employed as the modulation/demodulation system in this embodiment. In order to generate the signal of 2.4 GHz as the carrier of this AM modulation system, the PLL circuit 330 in the structure described above and the power amplifier 340 for amplifying the carrier generated by the PLL circuit 330 are formed on the semiconductor integrated circuit for communication 300.

The modulation circuit 310 is configured to output the signal obtained by AM-modulation of the carrier of 2.4 GHz with the signal of 100 kHz to the transmission terminal TX in order to generate the operation clock of 100 kHz from the receiving signal in the radio tag 400.

The semiconductor integrated circuit for communication 300 is provided with a reference oscillation circuit 350 for generating the reference oscillation signal φref of 1 MHz supplied to the PLL circuit 330, a frequency dividing circuit 365 for generating the signal of 100 kHz required by the modulation circuit 310 by dividing the frequency of the oscillation output of the reference oscillation circuit 350, a sequencer 370 for controlling internal operations of the chip such as adjustment of oscillation frequency by controlling the PLL circuit 330, a mixer MIX for generating the receiving signal converted to the predetermined frequency by mixing the output signal of the power amplifier 340 and the receiving signal, a demodulation circuit 320 for demodulating the data by detecting and amplifying the receiving signal, and a receiving register 390 for holding the demodulated data.

In this embodiment, the sequencer 370 is constituted to start the sequence for adjustment of oscillation frequency in the PLL circuit 330 when the power ON signal p-ON inputted from the external side rises to the high level from the low level. Namely, the sequencer 370 is constituted to have the function of the frequency adjustment control circuit 70 illustrated in FIG. 3.

In this embodiment, the sequencer 370 is configured to control the PLL circuit 330 to perform the oscillation frequency adjustment only when the power source voltage rises. However, it is also possible to provide a timer and a temperature sensor or the like to perform the oscillation frequency adjustment when the time has passed the predetermined time or when the temperature becomes higher than the predetermined temperature. Thereby, if the oscillation frequency range of the VCO varies due to temperature change, such oscillation frequency range can be corrected. In addition, the data held in the receiving register 390 is read serially to the external side of chip from a data output terminal DATA in synchronization with a clock CLK because the enable signal EN supplied from a microprocessor not illustrated is set to the valid level and the clock CLK is inputted.

Since an output of the power amplifier 340 has a higher amplitude level, the signal of 100 kHz included in the transmitting signal becomes a large noise element for the circuits of the receiving system. Therefore, it is advantageous in the present invention that the demodulation circuit 320 is not easily influenced by the noise element of 100 kHz included in the transmitting signal by supplying an modulated output of the power amplifier 340 to the mixer MIX as a local signal.

The embodiments of the present invention have been described above but the present invention is never limited thereto. For example, the VCO of the embodiment of FIG. 1 comprises a variable capacitance circuit 100 consisting of three capacitors C1, C2, C3 having weighted capacitances. But this variable capacitance circuit is not limited thereto and may also be configured with the four or more elements having the weighted capacitances.

Moreover, these capacitances are never limited to that formed by connecting in parallel the elements of unit capacitance and may also be formed of the elements having the areas of the relationship of 1:2:4: . . . :2^{m}. In addition, the switches SW1, SW2, SW3 connected in series to the weighted capacitances C1, C2, C3 are also not limited to three switches and each switch may be provided for every unit capacitance C0 illustrated in FIG. 2. However, in this case, it is also required to provide a decoder to decode the ON/OFF control signals VB1 to VB3 and thereby to change the number of switches to be turned ON in order to change the capacitance values to be connected.

Moreover, in the applied system of FIG. 5, the data is not transmitted to the radio tag 400 as the communication partner from the semiconductor integrated circuit comprising the PLL circuit of the embodiment but the data is received on the one-way basis from the radio tag. However, the semiconductor integrated circuit for communication 300 and radio tag 400 can naturally be formed to perform the two-way data communication.

In above description, the inventions of the present invention have been applied to the semiconductor integrated circuit for communication with the radio tag attached to product items which is the major application field. However, the present invention is never limited thereto and can be widely used for the semiconductor integrated circuit for communication with a chip which outputs a key code when it is inserted to the electronic key and the semiconductor integrated circuit comprising the VCO such as the semiconductor integrated circuit for communication used for radio communication system such as a mobile telephone.

The effects of the typical inventions of the present invention will be briefly described below.

Namely, according to the present invention, frequency adjustment of the VCO by the trimming using a probe can be eliminated in the semiconductor integrated circuit comprising the VCO. Thereby, reduction of cost can be realized. Moreover, since the oscillation frequency may be adjusted by varying capacitance value forming the LC resonance circuit, it is no longer required to change a current for adjustment of oscillation frequency. As a result, it is possible to attain the effect that fluctuation of current consumption in the oscillation circuit can be reduced.

What is claimed is:

1. A semiconductor integrated circuit comprising:
an oscillation circuit which includes inductance element and capacitance element and oscillates in the frequency depending on values of LC; and
a voltage comparing circuit for comparing a control voltage of said oscillation circuit with a reference voltage,
wherein said oscillation circuit is provided with a plurality of capacitance elements connected in parallel and a selection switch means, and can change LC values by selectively connecting any one of said plural capacitance elements with said selection switch means, and said selection switch means is controlled depending on the comparison result of said voltage comparing circuit to adjust the oscillation frequency of said oscillation circuit.

2. The semiconductor integrated circuit according to claim 1, wherein said plural capacitance elements respectively have the weights of 2^{m} (m:positive integer).

3. The semiconductor integrated circuit according to claim 1, wherein said plural capacitance elements are formed to have identical capacitance value with each other, these capacitance elements are divided to sets each of which is formed of 2^{m} elements, and each set is provided with a selection switch means.

4. A semiconductor integrated circuit comprising:
a PLL circuit including:
an oscillation circuit having inductance element and capacitance element to oscillate in the frequency depending on values of LC;
a frequency comparing circuit for comparing an oscillation output of said oscillation circuit with a frequency of a reference frequency signal;
a loop filter for generating a voltage corresponding to a frequency difference between the oscillation output of said oscillation circuit and the reference frequency signal by an output of said frequency comparing circuit, and then supplying this voltage to said oscillation circuit as an oscillation control voltage; and
a voltage comparing circuit for comparing the control voltage outputted from said loop filter with the reference voltage,
wherein said oscillation circuit is provided with a plurality of capacitance elements connected in parallel and a selection switch means to change the values of LC when any one of said plural capacitance elements is selectively connected by said selection switch means and said selection switch means is controlled depending on the comparison result of said voltage comparing circuit to adjust the oscillation frequency of said oscillation circuit.

5. The semiconductor integrated circuit according to claim 4, wherein said plural capacitance elements respectively have the weight of 2^{m} (m:positive integer)

6. The semiconductor integrated circuit according to claim 4, wherein said plural capacitance elements are formed with each other to have identical capacitance value, these capacitance elements are divided to sets each of which is formed of 2^{m} elements, and each set is provided with a selection switch means.

7. The semiconductor integrated circuit according to claim 4, further including a register for sequentially storing the comparison result of said voltage comparing circuit, and the signal of each bit of said register is supplied as a control signal to said selection switch means.

8. The semiconductor integrated circuit according to claim 7, wherein a transmission control means is provided between said voltage comparing circuit and said register to transfer or cut off an output of said voltage comparing circuit, and said transmission control means is set to become conductive when the power source voltage rises, controls said register to sequentially store the comparison result of said voltage comparing circuit and is usually in the cut-off condition during a normal oscillating operation.

9. A semiconductor integrated circuit for communication comprising:
a PLL circuit including:
an oscillation circuit having inductance element and capacitance element to oscillate in the frequency depending on values of LC;
a frequency comparing circuit for comparing an oscillation output of said oscillation circuit with a frequency of a reference frequency signal;
a loop filter for generating a voltage corresponding to a frequency difference between the oscillation output of said oscillation circuit and the reference frequency signal by an output of said frequency comparing circuit, and then supplying this voltage to said oscillation circuit as an oscillation control signal; and
a voltage comparing circuit for comparing the control voltage outputted from said loop filter with the reference voltage;
a power amplifying circuit for amplifying and outputting an output signal of said PLL circuit;
a modulation circuit for modulating an output signal of said PLL circuit by controlling a gain of said power amplifying circuit depending on the transmitting data; and
a demodulating circuit for demodulating the receiving signal.

10. The semiconductor integrated circuit for communication according to claim 9, comprising:
a detecting circuit for detecting an output signal of said power amplifying circuit; and
a mixer for outputting a frequency-converted signal by combining an output of said detecting circuit and the receiving signal.
